(19) United States
(12) Patent Application Publication
(10) Pub. No.: US 2025/0333826 A1
(43) Pub. Date: Oct. 30, 2025

(54) A NEW WELDING DUPLEX STAINLESS STEEL MATERIAL SUITABLE FOR WELDING A DUPLEX STAINLESS STEEL, A WELDED JOINT AND A WELDING METHOD THEREOF

(71) Applicant: ALLEIMA TUBE AB, Sandviken (SE)

(72) Inventors: Ulf KIVISÄKK, Sandviken (SE); Mats HÄTTESTRAND, Sandviken (SE); Peter STENVALL, Sandviken (SE); Johan LÖTHMAN, Sandviken (SE); Christina HARALDSSON, Sandviken (SE); Ulrika BORGGREN, Sandviken (SE); Mikael JOHANSSON, Sandviken (SE)

(73) Assignee: ALLEIMA TUBE AB, Sandviken (SE)

(21) Appl. No.: 18/855,349

(22) PCT Filed: Apr. 11, 2023
(86) PCT No.: PCT/EP2023/059458

§ 371 Date: Oct. 9, 2024

(30) Foreign Application Priority Data
Apr. 12, 2022 (EP) 22168046.5

(51) Int. Cl. C22C 38/54; B23K 35/30; B23K 103/04; C22C 38/00; C22C 38/02; C22C 38/04; C22C 38/06; C22C 38/42; C22C 38/44; C22C 38/46; C22C 38/48; C22C 38/50; C22C 38/52

(52) U.S. Cl. CPC C22C 38/54; B23K 35/3086; C22C 38/001; C22C 38/002; C22C 38/005; C22C 38/02; C22C 38/04; C22C 38/06; C22C 38/42; C22C 38/44; C22C 38/46; C22C 38/48; C22C 38/50; C22C 38/52; B23K 2103/05

(57) ABSTRACT

The present disclosure relates to a welding duplex stainless steel material comprising the following alloying elements in wt % C max 0.030 Si max 0.50 Mn 0.50 to 2.50 P max 0.030 S max 0.030 Cr 29.0 to 32.0 Ni 7.0 to 11.0 Mo 0.50 to 1.50 W 3.00 to 4.50 Cu max 0.50 N 0.25-0.45 Fe and unavoidable impurities Balance and having a ferrite:autenite content by volume of 35:65 to 65:35. The duplex stainless material can be in the form of a wire or a strip. The welding material will be used for joining duplex stainless steel and the welding material will have and also produce a welding joint which will have high strength The present disclosure further relates to a method of welding using the present welding material for single or multipass welding.

### TECHNICAL FIELD

The present disclosure relates to a new welding duplex stainless steel material, which can be in the form of a wire or a strip. The welding material intended be used for joining duplex stainless steel. The present disclosure further relates to a method of welding using the present welding material.

### BACKGROUND

In order to be able to introduce components such as tubes or strips of new alloy on the market, it is often necessary that these components can be welded. The welding material used should have essentially the properties the material of the component to avoid the produced welds constituting weak points in terms of mechanical properties (such as strength and toughness) and/or corrosion resistance.

There is within the oil and gas industry more and more demand for components composed of high alloyed duplex stainless steel having high strength as these materials are attractive due to their corrosion resistance and their good mechanical properties. However, it is difficult to find a welding material providing sufficient strength to the welded joints and which also can keep its strength and toughness when used in single and multipass welding.

Additionally, these high alloyed duplex stainless steels are also known to have a problem with nitrogen losses during welding when used as a filler material and there is therefore a need for a welding material which will reduce the negative impact on the strength and toughness in the welded joint these losses will have.

Hence, the present disclosure will solve or at least alleviate the problems mentioned above.

### FIGURES

The present disclosure is also illustrated by the following non-limiting Figures:

FIG. 1 shows intermetallic phases of Heat 1 of Examples, measured using LOM (Image analysis ×500 magnification);

FIG. 2 shows intermetallic phases of Heat 2 of Examples, measured using LOM (Image analysis ×500 magnification)

### SUMMARY

The present disclosure relates to a new welding duplex stainless steel material, which can be in the form of a wire or a strip. The welding material will be intended for joining duplex stainless steel and the welding material as such will have and also produce a welding joint which will have high strength The present disclosure further relates to a method of welding using the present welding material for single or multipass welding.

### DETAILED DESCRIPTION

The inventors of the present invention have found that by balancing the ranges of chromium, nickel, and nitrogen but also for Mo and W, a welding duplex stainless steel material suitable for welding a duplex stainless steel will be obtained.

The present welding duplex stainless steel material will have both high strength and toughness and also provide for a welded joint having high strength and toughness, even for a multipass formed welded joint. Additionally, when used in welding, the welding duplex stainless steel material will provide for low formation or no formation of intermetallic phases, such as sigma phase and unwanted nitrides, both in the joint and in the heat affected zone and the present welding duplex stainless steel material will also reduce the effects of nitrogen losses in the filler material during welding.

Furthermore, the inventive alloying element ranges of the welding duplex stainless material will assure that the effect of the welding process will have no negative impact on the ferrite: austenite balance and thereby ensure good mechanical properties and corrosion resistance of the welded joint. Furthermore, the present alloying ranges of the welding duplex stainless material will provide the material with a resistance to precipitation of intermetallic phases meaning that the material will maintain its ductility despite the, often repeated, heating associated with welding.

Hence, the present disclosure relates to a welding duplex stainless steel material comprising the following alloying elements in wt %

| | |
|---|---|
| C | max 0.030 |
| Si | max 0.50 |
| Mn | 0.50 to 2.50 |
| P | max 0.030 |
| S | max 0.030 |
| Cr | 29.0 to 32.0 |
| Ni | 7.0 to 11.0 |
| Mo | 0.50 to 1.50 |
| W | 3.00 to 4.50 |
| Cu | max 0.50 |
| N | 0.25-0.45 |
| Fe and unavoidable impurities | Balance |

and having a ferrite:autenite content by volume of 35:65 to 65:35.

In the present disclosure, the terms “weight %” and “wt %” are used interchangeably.

According to embodiments, the welding duplex stainless steel materials has a PRE ([Cr]+3.3x([Mo]+0.5x[W])+16x[N]) of ≥43 in order to provide sufficient corrosion resistance. The numerical values of the alloying elements are in weight %.

Further, the present disclosure relates to the hereinabove or whereinafter defined welding duplex stainless steel material for obtaining a welded joint. The welded joint will therefore comprise the alloying elements in the same ranges as the welding duplex stainless steel material as defined hereinabove or hereinafter.

The present disclosure also relates to a method for producing a welded joint containing the material as defined hereinabove or hereinafter, wherein the method is a single pass or a multipass welding method.

According to the present disclosure, the yield strength of the obtained welded joint may be at least 700 MPa (ISO 6892-1) at room temperature.

According to the present disclosure, the impact toughness at room temperature for the obtained welded joint may be at least 50 J (ISO 148-1).

The principles and advantages of the present welding duplex stainless steel material and the selection of the ranges of the alloying elements of the duplex stainless steel which renders the unexpected superiority can be described as follows below. The present disclosure is however not limited to the exemplifying embodiments discussed but may be varied within the scope of the appended claims. Upper and lower limits of the individual elements of the composition can be freely combined within the broadest limits set out in the claims, unless explicitly disclosed otherwise. Additionally, when ranges are disclosed in the present disclosure, such ranges include the respective end values of the range, unless explicitly disclosed otherwise. Similarly, when an open range is disclosed, the open range also include the single end value of the open range, unless explicitly disclosed otherwise.

### Chromium (Cr)

Chromium is an essential element, and the range has been selected in order to support both strength and corrosion resistance of the present duplex stainless steel. In order to have good strength properties, good impact properties and resistance to corrosion, the content of chromium should be equal to or at least 29.0 weight %.

However, even though chromium is a beneficial element, the content should not be more than or equal to 32.0 weight % as high contents of Cr will increase the risk of forming sigma phase during welding.

Further, the inventors have found that it is important to ensure a balanced content of chromium, nickel and nitrogen in order to avoid formation of sigma phase and to obtain the maximum strength. Further, as can be seen for the Examples of the present disclosure, the present chromium content has been shown to be more than enough to compensate for nitrogen losses occurring during a welding process, thereby avoiding reduction in strength.

Hence, the chromium content of the present welding duplex stainless steel material is therefore 29.0 to 32.0 weight %. In order to even further ensure that the above-mentioned properties are obtained, the chromium content is 29.5 to 32.0 wt %, such as 30.0 to 32.0 wt %, such as 30.5 to 31.5 wt. %

### Nickel (Ni)

Ni is used as an austenite-stabilizing element and is added to the present welding duplex stainless steel material at a suitable level in order to obtain the desirable content of austenite and ferrite. In order to obtain a ferrite: austenite ratio, by volume, of 35-65:65-35, the content of nickel should be equal to or at least 7.0 weight %. Furthermore, the inventors have found that the suggested content of nickel in the present welding duplex stainless steel material will provide for almost no formation of intermetallic phases, such as sigma phase and unwanted nitrides, and thus provide for a high impact toughness as sigma phase will have a negative impact on the impact toughness.

According to the present disclosure, the highest content of nickel is 11.0 weight %.

According to the present disclosure, the content of Ni may be 7.5 to 11.0 weight %, such as 8.0 to 11.0 weight %, such as 8.5 to 10.5 weight %.

### Molybdenum (Mo)

Mo is an active element which improves the strength and resistance to corrosion in chloride environments as well as in reducing acids.

However, an excessive Mo content in combination with a high Cr-content will increase the risk of formation of sigma phase. Thus, it is important that the content of molybdenum is selected so that formation of sigma phase is avoided in the welded joint and to obtain the maximum strength of the welded joint. Further, if the present welding duplex stainless steel material does not contain any Mo, too much nitrides will be formed during cooling.

Hence, the content of Mo should be in the range of equal to or at least 0.50 weight % and the content of Mo should be equal to or no more than 1.50 wt %. The content of Mo may also be equal or no more than 1.20 wt %. Further, the content of Mo may be at least 0.50 to 1.00 wt %.

### Tungsten (W)

W will improve the resistance to corrosion in chloride environments as well the resistance to pitting and crevice corrosion. However, a too high W content in combination with a high Cr content will increase the risk of precipitation of sigma phase in a welded joint. Hence, it is very important that the combined amount of chromium, molybdenum and tungsten is optimized to avoid formation of sigma phase and also unwanted nitrides.

The W content is therefore 3.00 to 4.50 wt %. According to embodiments, the content of W may be 3.00 to 4.00 wt %.

### Nitrogen (N)

N is a very active element and increases the resistance to corrosion as well as the strength. In order to obtain a good effect at least 0.25 weight % N should be added.

However, as added N must be dissolved in the welding duplex stainless steel material and the weld joint, the content of N must therefore be carefully selected as too high content of N will increase the risk of precipitation of chromium nitrides, especially when the content of chromium is also high. Too much nitrogen may also impose a risk for porosity formation in the welds. The N-content should therefore be limited to equal or less than 0.45 weight %.

Nitrogen is also a very important element for the microstructure of the weld and the welding material. During welding the welding material will lose a lot of nitrogen through evaporation due to the heat of the welding process. The nitrogen loss will result in that the welded joint will have a more ferritic microstructure with lager grains and nitride precipitates. These microstructural changes will have a negative impact on both the mechanical properties and the corrosion resistance of the weld. However, the present inventors have found a range of nitrogen for the present welding duplex stainless steel material wherein the effect of these losses will be reduced so that the welding duplex stainless steel material can lose nitrogen but still provide a welded joint with excellent mechanical properties and corrosion resistance.

Hence, the content of nitrogen is 0.25 to 0.45 weight %. Further, the content of N may be from 0.25 to 0.40 wt %, such as 0.25 to 0.35 wt %.

### Manganese (Mn)

Mn is added in order to increase the solubility of nitrogen. However, Mn may also form manganese sulphides, which act as initiation points for pitting corrosion. The content of Mn is therefore 0.50 weight % or greater and less than or equal to 2.50 weight %., the content of Mn may be 0.50 to 2.00 weight %, such as 0.50 to 1.50 weight.

### Silicon (Si)

Si is utilized as a deoxidizer during steel production and also improves fluidity of the molten weld metal. It is known that high silicon content stabilizes the sigma phase. The content of silicon should therefore be limited to max 0.50 weight %. As Si should be present, in order to provide the desired effect, Si may be present in a content of at least or equal to 0.05 wt %. Further, according to the present disclosure, the content of silicon may be 0.10 to 0.30 weight %.

### Carbon (C)

C strengthens stainless steel but also promotes the formation of chromium carbides which are harmful to corrosion. Carbon has also a limited solubility in both ferrite and austenite. The carbon content should therefore be limited to max 0.030 weight %, such as max 0.025 weight %.

Carbon is not a purposively added element, and there is no lower critical limit for the carbon content. However, striving towards very low carbon contents would unduly increase the processing costs. Therefore, in practice, carbon may be present in an amount of at least 0.01%, or even at least 0.02%.

According to embodiments, the carbon content is from 0.005 to 0.025 weight %.

### Copper (Cu)

Cu may be added in order to improve resistance to certain corrosive environments, such as acid environments, and decrease the susceptibility to stress corrosion cracking. Furthermore, Cu will increase the strength and also retard the formation of sigma phase in the welded joint.

Thus, copper is a beneficial alloying element for increasing the strength but because of the negative effect on nitrogen solubility, this element may increase the risk of formation of chromium nitrides. It is therefore very important to carefully adjust the amount of copper if added.

The content of Cu is therefore limited to equal to or less than 0.50 wt %. According to an embodiment, Cu is purposively added, and the content of Cu is between 0.15 to 0.50 wt %, According embodiments, the Cu content may be 0.20 to 0.40 wt %.

### Sulfur(S)

Sulfur is an impurity element, and it must be removed in order to improve the hot workability. The sulfur content should not be more than 0.030 wt %, so that the adverse effect of sulfur can be avoided.

### Phosphorus (P)

Phosphorus is also an impurity element and when the total phosphorus content is not more than 0.030 wt %, its adverse effect on the hot workability is diminished.

The ferrite content of the present welding material the ratio of ferrite:austenite, by volume, is between 35-65:65-35, According to embodiments, the ferrite content is at least or equal to 45 vol %, and should not exceed 60 vol %, the reminder essentially being austenite.

According to embodiments, the ferrite content is in the range of 48 to 55 vol %, the reminder essentially being austenite. The phase balance is important in welding duplex stainless steel material as it helps to obtain optimum mechanical properties and corrosion resistance. Additionally, too low ferrite content will increase the risk of formation of intermetallic phases, such as sigma phase and unwanted nitrides, as the ferrite will be rich in chromium and molybdenum. Further. too high ferrite content will increase the risk of formation of secondary austenite within the ferrite grains. The amount of ferrite may be measured metallographically by investigating the weld metal microstructure at 200-500× magnification, etched to distinguish ferrite and austenite by color. The volume percentage is an area fraction of the two.

The number of phase(s) in the microstructure is given in volume-% (vol.-%) throughout the present disclosure. It should here be recognized that a certain volume percentage is generally determined within this technical field by considering an area percentage of the relevant constituent component (phase) in a sample, said area percentage considered to correspond to the volume percentage.

The balance of present welding duplex stainless steel material is iron (Fe) and unavoidable impurities. The unavoidable impurities are elements which are not added on purpose but may be in the present steel due to the scrap and/or manufacturing process used for providing the duplex stainless steel. Examples of such elements but not limited thereto are Co, V, Ti, Al, Nb, Pb and Sn. The combined content of these elements is less than 0.5 wt %. Cerium (Ce) may also be present as an impurity, but cerium cannot be more than 0.07 wt % as this will cause problems during welding due to disturbance with the welding arc due to moving cathode spot from Ce/O forming.

Further, the present welding material may optionally comprise alloying elements which may have been added in order to improve the manufacturing process. Examples but not limiting to such manufacturing process improving alloying elements are Magnesium (Mg), Calcium (Ca) and Boron (B). These elements could be added individually or combined, and content of these elements is less than 0.50 weight % in total.

Other impurity elements, not discussed above, may be present in an amount of less than 0.1 wt % and the total amount thereof being less than 0.5%.

Additionally, the present welding duplex stainless steel material may comprise or consist of the alloying elements mentioned herein in any of the ranges of the specific elements mentioned herein and fulfilling the requirements mentioned herein.

According to embodiments, the present welding duplex stainless steel material is in the form of a welding wire or a welding strip or a welding powder.

The present welding duplex stainless steel material as defined hereinabove or hereinafter, may be manufactured in a process comprising the following steps:
Melting the raw material: The melting may be performed by a high frequency induction furnace or an arc furnace.
Casting;
Optionally solution annealing in a temperature range of 1000 to 1150° C. and thereafter quenching in water;
Hot working: The hot working may be performed by forging and/or rolling and/or extrusion;
Optionally solution annealing in a temperature range of 1000 to 1150° C. and thereafter quenching in water; and
Cold working: The cold working may be performed by drawing or rolling.

If a powder is to be manufacture. after melting conventional powder manufacturing processes are used.

The present disclosure also relates to a welded joint. The welded joint is obtained by the following method comprising the steps of:
Providing the welding duplex stainless steel material as defined hereinabove or hereinafter: The material is provided in the form of for example in the form of for example a wire or a strip:
Providing at least one base material to be welded: Example of, but not limited to, a base material is a duplex stainless steel in the form of a tube of a material such as materials sold by Alleima under the tradenames SAF™ 2507 and SAF™ 2906.
Applying said welding duplex stainless steel material to and/or on the base material;
Applying a shielding gas or a flux powder to the region of the welded joint to be obtained;
Welding together the base material with the welding duplex stainless steel material by using Tungsten Inert Gas or Metal Inert Gas/Metal Active Gas or Submerged Arc Welding or Electro Slag Welding.

If the welded joint is a multipass joint, the application of the welding duplex stainless steel material will occur several times. The welding material is allowed to cool before a new layer of welding material is applied.

The present disclosure is further described by the following non-limiting examples.

### EXAMPLES

Two heats were formed having the chemical compositions as shown in Table 2.

The heats were formed by melting raw and scrap materials using an induction furnace. The melts were cast, and the cast products were solution annealed at a temperature range of 1000 to 1100° C. during about 0.5 to 2 h and then quenched in water. The formed billets were hot rolled and then drawn to a wire. The formed wires were then welded to a base material of a duplex stainless material of similar composition using TIG and a shielding gas comprising essentially argon and nitrogen.

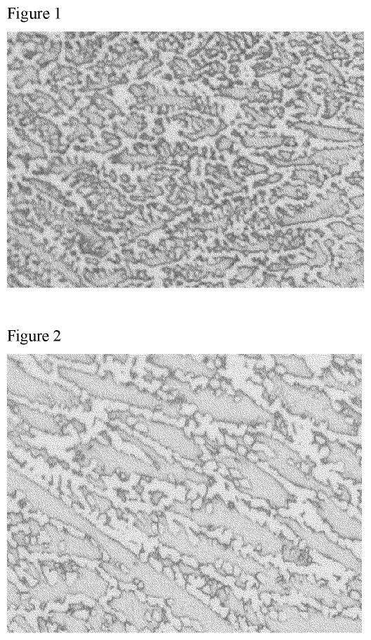

Samples were taken from the welded joints by cutting and milling and the obtained samples tested according to the following:
Standard ISO 6892-1 was used for measuring Rp0.2 in room temperature.
Impact toughness was measured by measuring Charpy V both in room temperature and at −46° C.,
The ferrite content was measured using LOM-(Image analysis ×500 magnification).
The image analysis measured the area fraction of the different phases.
Intermetallic phases were measured using LOM (Image analysis ×500 magnification)—see FIGS. 1 and 2.

No intermetallic (unwanted nitrides) particles, were seen in the LOM images during visual analysis.

The result of the testing is shown in Table 1. As can be seen from the result, the welding duplex stainless steel provide a welded joint with high mechanical strength, no intermetallic phases and good impact toughness. The PRE indicates high corrosion resistance.

TABLE 1
Results of the tests

| Measurements | Heat 1 | Heat 2 |
|---|---|---|
| PRE | 45.4 | 44.6 |
| ([Cr] + 3.3x([Mo] + 0.5x[W]) + 16x[N]) | | |
| Values in equation are in wt % | | |
| Rp0.2 [MPa] (ISO 6892-1) (room | 850 | 842 |
| temperature) | | |
| Charpy-V −46° C. (J) (ISO 148-1) | 42 | 77 |
| Charpy-V RT (J) (ISO 148-1) | 76 | 129 |
| Ferrite (%) (Image analysis x500 | 55 | 53 |
| magnification) | | |
| Intermetallic phases (%) (Image | 0 | 0 |
| analysis x500 magnification) | | |

TABLE 2
The chemical composition of the Examples

Heat

| Element | 1* | 2* |
|---|---|---|
| C | 0.014 | 0.010 |
| Si | 0.22 | 0.18 |
| Mn | 0.98 | 0.94 |
| P | 0.011 | 0.012 |
| S | 0.0008 | 0.0015 |
| Cr | 31.66 | 31.30 |
| Ni | 10.32 | 8.97 |
| Mo | 0.84 | 0.83 |
| Co | 0.030 | 0.033 |
| Cu | 0.27 | 0.27 |
| N | 0.316 | 0.31 |
| Al | 0.040 | 0.023 |
| B | 0.0019 | 0.0014 |
| Nb | 0.01 | 0.01 |
| Ti | <0.003 | <0.003 |
| Fe | 51.52 | 53.6 |
| Ce | 0.05 | 0.02 |
| V | 0.077 | 0.075 |
| W | 3.58 | 3.41 |

The heats marked with a “*” are inventive heats, numbers are in weight %.

1. A welding duplex stainless steel material, comprising the following alloying elements in wt %;

| | |
|---|---|
| C | max 0.030 |
| Si | max 0.50 |
| Mn | 0.50 to 2.50 |
| P | max 0.030 |
| S | max 0.030 |
| Cr | 29.0 to 32.0 |
| Ni | 7.0 to 11.0 |
| Mo | 0.50 to 1.50 |
| W | 3.00 to 4.50 |
| Cu | max 0.50 |
| N | 0.25-0.45 |
| Fe and unavoidable impurities | Balance |

and having a ferrite: autenite content, by volume, of 35:65 to 65:35.

2. The welding duplex stainless steel material according to claim 1, wherein the PRE is ≥43 and wherein PRE is calculated from the formula: [Cr]+3.3x([Mo]+0.5x[W])+16x[N], wherein the values of the alloying elements are in wt %.

3. The welding duplex stainless steel material according to claim 1, wherein the content of Cr is in the range of from 29.5 to 32.0 wt %.

4. The welding duplex stainless steel material according to claim 1, wherein the content of Mn is in the range of from 0.50 to 1.00 wt %.

5. The welding duplex stainless steel material according to claim 1, wherein the content of Si is in the range of from 0.10 to 0.30 wt %.

6. The welding duplex stainless steel material according to claim 1, wherein the content of W is in the range of from 3.00 to 4.00 wt %.

7. The welding duplex stainless steel material according to claim 1, wherein the content of N is in the range of from 0.25 to 0.40 wt %.

8. The welding duplex stainless steel material according to claim 1, wherein the content of N is in the range of from 0.25 to 0.35 wt %.

9. The welding duplex stainless steel material according to any one of previous claims claim 1, wherein the ferrite:austenite content, by volume, is in the range of 48:52 to 55:45.

10. The welding duplex stainless steel material according to claim 1, wherein the welding material has a Rp0.2 of at least 700 MPa, determined according to ISO 6892-1 in room temperature.

11. Use of the welding duplex stainless steel material according to claim 1, for obtaining a welded joint.

12. A method for producing a welded joint containing the welding duplex stainless steel material according to claim 1, wherein the method is a multipass welding method or a single pass welding method.

13. The method according to claim 12, wherein the obtained welded joint has a Rp0.2 of at least 700 MPa, determined according to ISO 6892-1 in room temperature.

14. The method according to claim 12, wherein the obtained welded joint has an impact toughness of at least 40 J or 50 J determined according to ISO 148-1 in −46° C.

15. The method according to claim 12, wherein said method comprises the steps of any one of the previous claims claim 1
providing a welding duplex stainless steel material according to any one of claims 1 to 10;
providing at least one base material to be welded;
applying said welding duplex stainless steel material to and/or on the base material;
applying a shielding gas or a flux powder to a region of a welded joint to be obtained; and
welding the base material together with the welding duplex stainless steel material by using Tungsten Inert Gas or Metal Inert Gas/Metal Active Gas or Submerged Arc Welding or Electro Slag Welding,
wherein the welding duplex stainless steel material includes the following alloying elements in wt %:

| | |
|---|---|
| C | max 0.030 |
| Si | max 0.50 |
| Mn | 0.50 to 2.50 |
| P | max 0.030 |
| S | max 0.030 |
| Cr | 29.0 to 32.0 |
| Ni | 7.0 to 11.0 |
| Mo | 0.50 to 1.50 |
| W | 3.00 to 4.50 |
| Cu | max 0.50 |
| N | 0.25-0.45 |
| Fe and unavoidable impurities | balance, and |

wherein the welding duplex stainless steel material has a ferrite:autenite content, by volume, of 35:65 to 65:35.

16. The welding duplex stainless steel material according to claim 1, wherein the content of Cr is in the range of from 29.5 to 32.0 wt %,
wherein the content of Mn is in the range of from 0.50 to 1.00 wt %,
wherein the content of Si is in the range of from 0.10 to 0.30 wt %,
wherein the content of W is in the range of from 3.00 to 4.00 wt %, and
wherein the content of N is in the range of from 0.25 to 0.40 wt %.
